(19) United States
(12) Patent Application Publication
(10) Pub. No.: US 2013/0124957 A1
(43) Pub. Date: May 16, 2013

(54) STRUCTURED MODELING OF DATA IN A SPREADSHEET

(71) Applicants: Diego M. Oppenheimer, Seattle, WA (US); Allan Folting, Redmond, WA (US); Anatoly V. Grabar, Redmond, WA (US); Stephen Van de Walker Handy, Bremerton, WA (US)

(72) Inventors: Diego M. Oppenheimer, Seattle, WA (US); Allan Folting, Redmond, WA (US); Anatoly V. Grabar, Redmond, WA (US); Stephen Van de Walker Handy, Bremerton, WA (US)

(73) Assignee: MICROSOFT CORPORATION, Redmond, WA (US)

(21) Appl. No.: 13/294,824

(22) Filed: Nov. 11, 2011

(51) Int. Cl. G06F 17/00

(52) U.S. Cl. 715/212

(57) ABSTRACT

Data displayed on a spreadsheet and data from one or more data sources are used to create a model within the spreadsheet. The data may be obtained from many types of data sources, such as: relational databases, multidimensional sources, cloud services, data feeds, spreadsheet files, text files, data from the Web, and the like. A modeling engine of the spreadsheet application creates the model that structures the data, relates different pieces of data, and provides context for the data. The model that may be stored within the spreadsheet includes the raw data and metadata that describes the data and provides the context for the data. The model may be automatically updated based on performed operations of the spreadsheet. The model may be examined using a query language (e.g. MDX, DAX, SQL, Spreadsheet Functions and Formulas, . . . ) to examine the data and the relationships obtained from the spreadsheet and data sources.

### BACKGROUND

Spreadsheets include data that is displayed in rows and columns. A user may perform different operations on the data such as filtering the data, sorting the data and displaying the data. Some of the data within the spreadsheet may come from different data sources and/or copy/paste operations. Analyzing the data that is displayed by the spreadsheet application can be difficult.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Data displayed on a spreadsheet and data obtained from one or more data sources are used to create a model within the spreadsheet. The data may be obtained from many types of data sources, such as: relational databases, multidimensional sources, cloud services, data feeds, spreadsheet files, text files, data from the Web, and the like. A modeling engine of the spreadsheet application creates the model that describes a structure of the data, relates different pieces of data, and provides context for the data. The model may be stored within the spreadsheet and includes raw data obtained from the different data sources and the spreadsheet and metadata that describes the data and provides context for the data. The raw data may be stored in a format optimized for querying/reporting operations. The model may be automatically updated based on performed operations of the spreadsheet. The model may be queried using a query language (e.g. MDX, DAX . . . ) to examine the data and the relationships obtained from the spreadsheet and the one or more data sources.

### BRIEF DESCRIPTION OF THE DRAWINGS

FIG. 1 illustrates an exemplary computing device;

FIG. 2 illustrates an exemplary system for creating and using a model that combines, structures, and relates data in a spreadsheet as well as data from other data sources;

FIG. 3 shows a process for creating a model that combines and structures data from one or more data sources with displayed data from a spreadsheet;

FIG. 4 shows a process for determining a structure, metadata and relationships that are associated with the metadata; and

FIG. 5 shows a process for querying the model.

### DETAILED DESCRIPTION

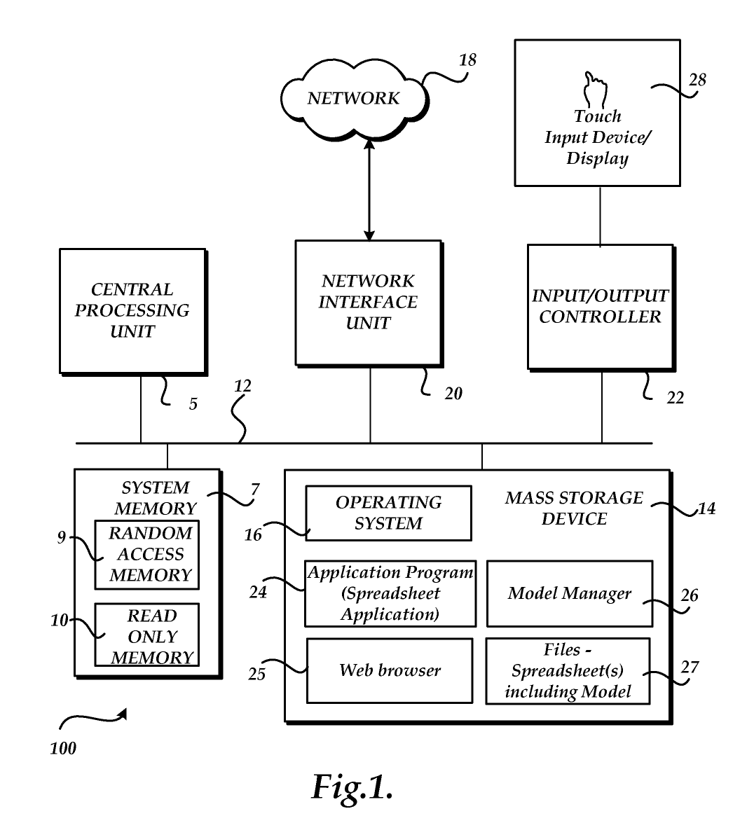

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a mobile computing device (e.g. smartphone, notebook, tablet . . . ) or desktop computer and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application program(s) 24 such as a spreadsheet application, Web browser 25, files 27 (e.g. spreadsheets) and model manager 26 which will be described in greater detail below. The Web browser 25 is operative to request, receive, render, and provide interactivity with electronic content, such as Web pages, videos, documents, and the like. According to an embodiment, the Web browser comprises the INTERNET EXPLORER Web browser application program from MICROSOFT CORPORATION.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a touch input device 28. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device 28 may also act as a display. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, may be integrated with other components of the computing device/system 100 on the single integrated circuit (chip).

As mentioned briefly above, a number of program modules and data files may be stored in the mass storage device 14 and RAM 9 of the computer 100, including an operating system 16 suitable for controlling the operation of a networked personal computer, such as the WINDOWS 7® operating system from MICROSOFT CORPORATION of Redmond, Wash. According to one embodiment, the operating system is configured to include support for touch input device 28. According to another embodiment, model manager 26 may be utilized to process some/all of the touch input that is received from touch input device 28.

The mass storage device 14 and RAM 9 may also store one or more program modules. In particular, the mass storage device 14 and the RAM 9 may store one or more application programs 24, such as a spreadsheet application. In conjunction with the operation of the spreadsheet application, model manager 26 is configured to create a model from data displayed on a spreadsheet and data from one or more data sources. Model manager 26 may be configured as an application/process and/or as part of a cloud based multi-tenant service that provides resources (e.g. services, data . . . ) to different tenants (e.g. MICROSOFT OFFICE 365, MICROSOFT SHAREPOINT ONLINE).

Generally, model manager 26 is configured to create a model from data displayed on a spreadsheet and data from one or more data sources. The data may be obtained from many types of data sources, such as: relational databases, multidimensional sources, cloud services, data feeds, spreadsheet files, text files, data from the Web, and the like. Model manager 26 uses a modeling engine of the spreadsheet application to create the model that imports any existing structure of the data (when structure exists) and adds additional structure that relates different pieces of data, and provides context for the data. The model may be stored within the spreadsheet and includes the raw data and metadata that describes the data and provides the context for the data. According to an embodiment, the ray data is stored in a format optimized for fast response times when reporting on/querying the data. The model may be automatically updated based on performed operations on the spreadsheet. The model may be queried using a query language (e.g. MDX, DAX, SQL, Spreadsheet Functions and Formulas, . . . ) to examine the data and the relationships obtained from the spreadsheet and one or more data sources. Additional details regarding the operation of model manager 26 will be provided below.

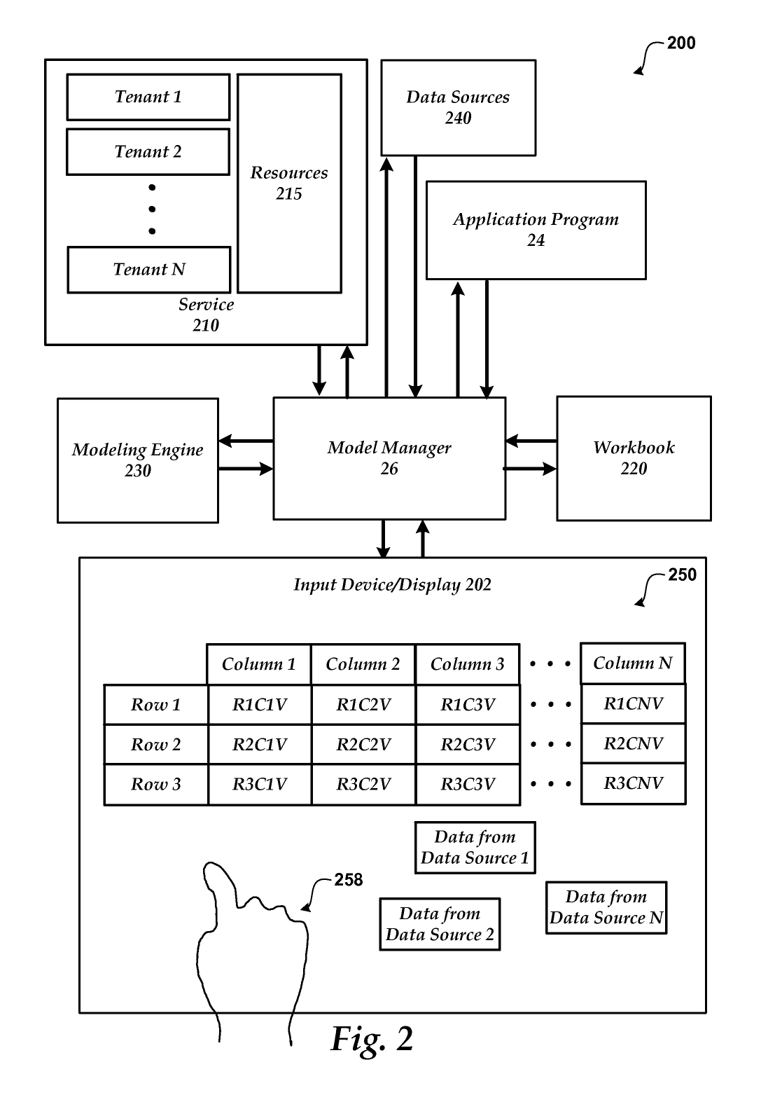

FIG. 2 illustrates an exemplary system for creating and using a model that combines, structures, and relates data in a spreadsheet as well as data from other data sources. As illustrated, system 200 includes application program 24, service 210, model manager 26, modeling engine 230, workbook 220, data sources 240 and input device/display 202. According to an embodiment, display 202 is a touch screen device.

According to an embodiment, application program 24 is a spreadsheet application that is configured to receive input from one or more input devices (e.g. a touch-sensitive input device 202, a keyboard, a mouse, a stylus . . . ). For example, model manager 26 may provide information to application 24 and/or service 210 in response to a user's finger (i.e. finger on hand 258) selection of a data source and/or data selected from one or more cells of a spreadsheet (e.g. spreadsheet 250), and the like.

As illustrated, service 210 is a cloud based and/or enterprise based service that is configured to provide services relating to one or more productivity applications (e.g. MICROSOFT EXCEL, MICROSOFT SHAREPOINT, MICROSOFT WORD). Service 210 may also be configured as a client based application. Although system 200 shows a productivity service and/or a content management service, other services/applications may be configured to create a model that combines spreadsheet data and data from one or more other sources.

As illustrated, service 210 is a multi-tenant service that provides resources 215 and services to any number of tenants (e.g. Tenants 1-N). According to an embodiment, multi-tenant service 210 is a cloud based service that provides resources/services 215 to tenants subscribed to the service and maintains each tenant's data separately and protected from other tenant data. For example, service 210 may be configured to provide services corresponding to productivity applications (e.g. spreadsheet, content management, and the like).

Touch input system 200 as illustrated comprises a touch screen input device 202 that detects when a touch input has been received (e.g. a finger touching or nearly teaching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

Data sources 240 may be any type of data source that includes data that includes an explicit structuring and/or an implicit structuring. For example, data sources 240 may include relational databases, multidimensional sources, cloud services, data feeds, spreadsheet files, text files, data from the Web, and the like. Data sources 240 may include pre-defined tables, columns of data, related data, and the like.

Modeling engine 230 is configured to create a model of spreadsheet data that is displayed on a sheet and data that is obtained from one or more data sources. According to an embodiment, modeling engine 230 is an in-memory multidimensional data analysis engine that is loaded with the application/service that is used when viewing spreadsheet 250. According to an embodiment, the modeling engine is the VERTIPAQ engine from MICROSOFT CORPORATION. Modeling engine 230 creates/loads a model into memory when the model is being used. According to an embodiment, when the spreadsheet (e.g. spreadsheet 250) is closed, the model is saved within the spreadsheet file (e.g. workbook 220). Modeling engine 230 is configured to create/obtain metadata that includes identifying metadata (e.g. source of data, name of data, name of columns/rows, tables, table names, number of data items, . . . ) and contextual metadata (e.g. relationships between data, ways to present the data (e.g. type of data), grouping of tables, calculations relating to the data, key performance indicators (KPIs) about the data, and the like).

Model manager 26 is configured to create and use a model from the data displayed on a spreadsheet and data from one or more data sources. Model manager 26 uses modeling engine 230 of the spreadsheet application to create the model that structures the data, relates different pieces of data, and provides context for the data. Model manager 26 may determine a structure of data based on an analysis of the data. Model manager 26 may determine a context for the data, header(s) for the data, uses of the data, and the like, to determine a likely structure of the data. For example, data in a column of a spreadsheet that includes a heading and includes numerical values ranging between 0 and 100 may be structured as being related to the heading.

All/some of the data from a spreadsheet (e.g. spreadsheet 250) may be included within the model. According to an embodiment, all of the data from the spreadsheet is automatically included within the model. According to another embodiment, data from the spreadsheet is included within the model in response to an operation performed on the data in the spreadsheet and data obtained from a data source (e.g. a user associating a row/column of data with data selected from a data source, combining two tables, relating a table . . . ).

The model may be examined using a query language (e.g. using MultiDimensional eXpressions (MDX), Data Analysis Expressions (DAX), Structured Query Language (SQL), Spreadsheet Functions and Formulas, . . . ). For example, a user may query the model to find data that meets one or more conditions. The model may be automatically updated in response to queries. For example, data within the model may be related in response to a query that obtains data from one table and data from a column of the spreadsheet. In response to the query, the model manager 26 obtains and returns the results. The model manager may also store the information about the user selection of the different data sources together in a report and use that knowledge for future operations to suggest relevant data in new reports based on past actions.

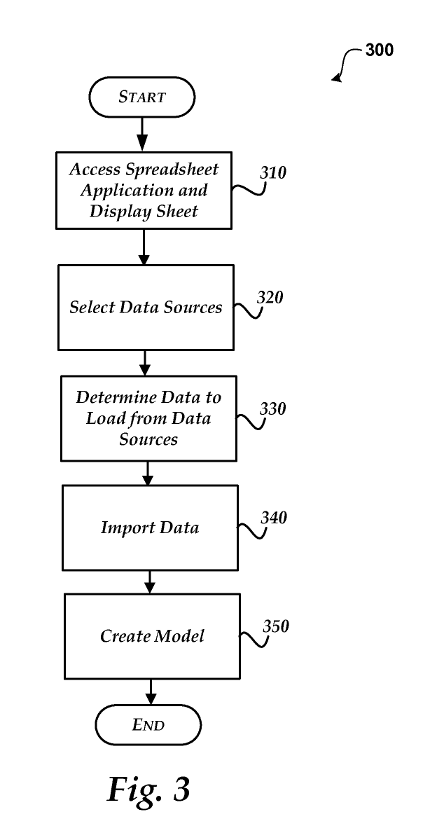

Referring now to FIGS. 3-5, illustrative processes for structuring data in a spreadsheet application will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 3 shows a process for creating a model that combines and structures data from one or more data sources with displayed data from a spreadsheet.

After a start operation, process 300 flows to operation 310, where a spreadsheet application is accessed and a sheet is displayed that includes a display of data arranged in rows and columns. For example, a user may access a client spreadsheet application and/or a spreadsheet service and display a sheet of a workbook.

Flowing to operation 320, one or more data sources from which to obtain data is selected. The data sources may include structured data (e.g. data associated with an explicit structure, such as data obtained from a database, pre-defined tables, pivot tables) and/or unstructured data (e.g. data that is not associated with an explicit data such as data from a column of a spreadsheet, file . . . ). The data sources may include relational databases, multidimensional sources, cloud services, data feeds, spreadsheet files, text files, data from the Web, and the like. A user may select the data source(s) from a user interface of the spreadsheet application and/or through another selection method.

Transitioning to operation 330, a determination is made as to what data to load from the selected data sources. All/portion of the data may be loaded. The determination may be performed manually/automatically. A user may select the data that they would like to include in the model (e.g. tables, columns, graphs, charts, . . . ). The data may also be automatically selected for inclusion in the model. For example, when the data is below a predetermined size (e.g. number of data items) the entire data from the data source may be loaded, when the data meets predetermined conditions (e.g. a search query) the matching data may be selected for inclusion within the model. According to an embodiment, all of the data that is displayed on a sheet of the spreadsheet application is identified to be loaded. According to another embodiment, data from the spreadsheet is loaded when it is associated with data from one of the selected data sources.

Moving to operation 340, the data is imported/loaded into the model. According to an embodiment, the raw data and any metadata obtained from the data source is included within the model. Some data may include more explicit structure and metadata then other data (e.g. data from a database as compared to data within a text file). When the data is unstructured, a structure may be attempted to be determined based on an automated analysis of the data (e.g. examining the selected data and/or other data near the selected data, uses of the data, user interaction with the data . . . ) and/or a manual analysis of the data (receiving metadata from a user that describes the data).

Flowing to operation 350, the model is created. According to an embodiment, the model is created by an in-memory modeling engine that is associated with the spreadsheet application.

The process then flows to an end operation and returns to processing other actions.

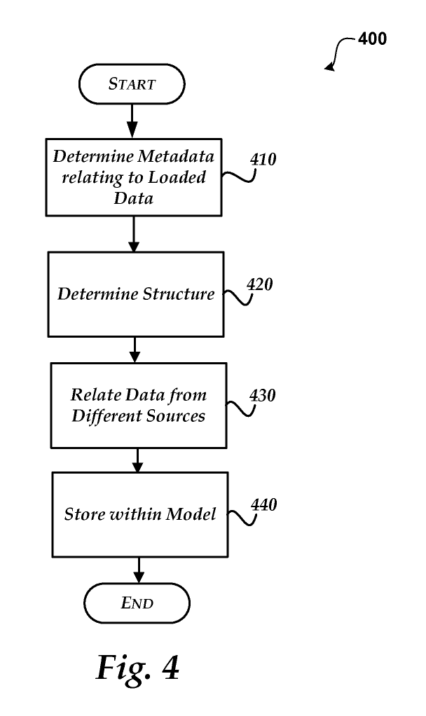

FIG. 4 shows a process for determining a structure, metadata and relationships that are associated with the metadata.

After a start operation, process 400 flows to operation 410, where metadata relating to the loaded data for the model is determined The determination of the metadata may include determining metadata that describes the data such as: identifying a source of data, a name of data, a name of columns/rows, tables within the data, table names, a number of data items, and the like. The determination of the metadata also includes determining metadata that describes a context of the data such as: relationships between data, ways to present the data (e.g. type of data), grouping of tables, calculations relating to the data, key performance indicators (KPIs) about the data, and the like.

Flowing to operation 420, a structure of the data is determined The structure may be determined from the explicit structuring of the data (e.g. a table, database, pivot table, . . . ) and/or an implicit structuring of the data (e.g. analyzing the data to determine a structure).

Transitioning to operation 430, data from the different data sources may be related. For example, a user may make selections that associate data from one data source with the spreadsheet data and/or other data from other data sources. The data may also be related through calls to the model to associate data (e.g. associate column 1 of data source 1 with table 2 of data source 2).

Moving to operation 440, the metadata, structure and relationships are stored within the model.

The process then flows to an end operation and returns to processing other actions.

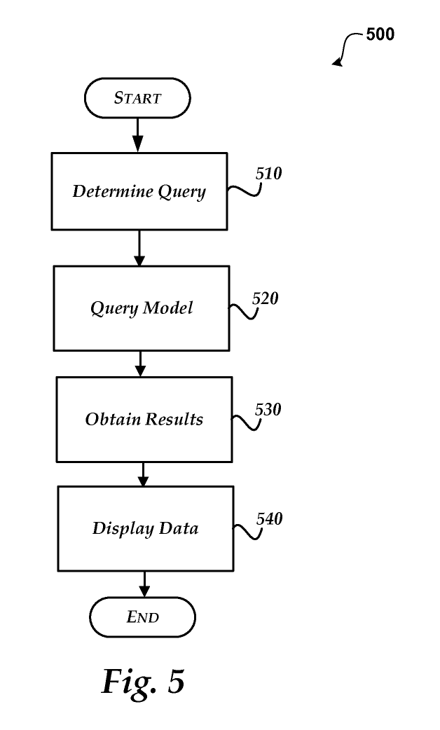

FIG. 5 shows a process for querying the model.

After a start operation, process 500 flows to operation 510, where a query is determined. The query may be a user-defined query and/or a query generated by the spreadsheet application (e.g. execution of a function within the spreadsheet).

Flowing to operation 520, the model is queried. According to an embodiment, the query is uses a query language (e.g. MDX, DAX, SQL, Spreadsheet Functions and Formulas, . . . ) to examine the data and the relationships as defined within the model.

Transitioning to operation 530, the results of the query are obtained.

Moving to operation 540, the data is displayed according to the obtained results.

The process then flows to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for using a model that structures data included from data in a spreadsheet and data from an external data source, comprising:
displaying a spreadsheet that includes data arranged in rows and columns;
determining data to include within the spreadsheet from an external data source;
creating a model that provides a structure for data including data from the external data source and data that is displayed on the spreadsheet;
from the spreadsheet, querying the model using a query language;
obtaining the results; and
updating a display of the spreadsheet based on the results.

2. The method of claim 1, wherein creating the model comprises determining a structure from the data that is displayed on the spreadsheet.

3. The method of claim 1, further comprising analyzing a layout of the data from at least one of: the data that is displayed on the spreadsheet and the data from the external data source to determine a structure.

4. The method of claim 1, further comprising updating the model in response to operations performed using the model and the spreadsheet.

5. The method of claim 1, further comprising storing the model in a spreadsheet file that also stores the spreadsheet data.

6. The method of claim 1, further comprising automatically loading the data that is displayed on the spreadsheet; determining a structure of the loaded data and determining metadata that describes the loaded data.

7. The method of claim 1, further comprising, the spreadsheet application loading a modeling engine.

8. The method of claim 1, wherein the model comprises raw data from the data source and from the spreadsheet and metadata that describes the raw data.

9. The method of claim 1, wherein the metadata comprises names for the data, a number of columns, a number of rows, different relationships between the data sources, and KPIs.

10. A computer-readable medium having computer-executable instructions for using a model that structures data included from data in a spreadsheet and data from an external data source, comprising:
displaying a spreadsheet that includes data arranged in rows and columns;
selecting data from an external data source;
determining a structure of the data that is displayed on the spreadsheet;
creating a model that includes the selected data, the data that is displayed on the spreadsheet, a structure of the selected data and the determined structure of the data that is displayed on the spreadsheet;
querying the model using a query language;
obtaining the results; and
updating a display of the spreadsheet based on the results.

11. The computer-readable medium of claim 10, further comprising analyzing a layout and headers of the data from at least one of: the data that is displayed on the spreadsheet and the data from the external data source to determine a structure.

12. The computer-readable medium of claim 10, further comprising updating the model in response to operations performed using the model and the spreadsheet.

13. The computer-readable medium of claim 10, further comprising storing the model in a spreadsheet file that also stores the spreadsheet data and the selected data.

14. The computer-readable medium of claim 10, further comprising automatically loading the data in the model that is displayed on the spreadsheet.

15. The computer-readable medium of claim 10, further comprising, the loading a modeling engine that executes in-memory of the spreadsheet application.

16. The computer-readable medium of claim 10, wherein the model comprises names for the data, a number of columns, a number of rows, different relationships between the data sources, and KPIs.

17. A system for using a model that structures data included from data in a spreadsheet and data from an external data source, comprising:
a display;
a spreadsheet application;
a modeling engine;
a processor and a computer-readable medium;
an operating environment stored on the computer-readable medium and executing on the processor; and
a process configured to perform actions, comprising:
displaying a spreadsheet associated with the spreadsheet application that includes data arranged in rows and columns;
selecting data from an external data source;
determining a structure of the data that is displayed on the spreadsheet;
creating a model that includes the selected data, the data that is displayed on the spreadsheet, a structure of the selected data and the determined structure of the data that is displayed on the spreadsheet;
storing the model in a spreadsheet file that includes the data that is displayed on the spreadsheet;
querying the model using a query language;
obtaining the results; and
updating the display of the spreadsheet based on the results.

18. The system of claim 17, further comprising analyzing a layout and headers of the data from at least one of: the data that is displayed on the spreadsheet and the data from the external data source to determine a structure.

19. The system of claim 17, further comprising updating the model in response to operations performed using the model and the spreadsheet.

20. The system of claim 17, further comprising automatically loading the data in the model that is displayed on the spreadsheet.
